(19) United States
(12) Patent Application Publication
(10) Pub. No.: US 2008/0256930 A1
(43) Pub. Date: Oct. 23, 2008

(54) ENERGY SYSTEM AND METHOD FOR RECYCLING FUELS

(76) Inventors: Mark Wechsler, San Mateo, CA (US); Arthur M. Shulenberger, Milbrae, CA (US)

Correspondence Address: STEVEN VOSEN, 1563 SOLANO AVENUE #206, BERKELEY, CA, 94707, US

(21) Appl. No.: 12/104,714

(22) Filed: Apr. 17, 2008

Related U.S. Application Data
(60) Provisional application No. 60/912,766, filed on Apr. 19, 2007.

(51) Int. Cl. F02M 25/00

(52) U.S. Cl. 60/278

(57) ABSTRACT

A closed energy system using carbon-containing fuels is described. The system includes a utilization portion, where a fuel is stored and consumed, and a recycling portion, where the products of utilization are recycled into fuel. In one embodiment, dimethyl ether is used as a fuel. The utilization of the fuel produces carbon dioxide, which is stored for later recycling. In one embodiment, solar energy is used in the recycling of materials. In certain embodiments, a fueling station is provided that recycles waste from the utilization of the fuel.

### CROSS-REFERENCE TO RELATED APPLICATIONS

This application claims the benefit of U.S. Provisional Application No. 60/912,766, filed Apr. 19, 2007, the entire contents of which are hereby incorporated by reference herein and made part of this specification.

### BACKGROUND

1. Field of the Invention

The present invention generally relates to energy systems and method of operating energy systems, and more particularly to apparatus and methods for energy system that have the potential to reduce or eliminate carbon emissions.

2. Discussion of the Background

The reduction of greenhouse gases, such as carbon dioxide, is increasingly recognized as a desirable environmental goal. The transportation sector is one area where it will be difficult to eliminate carbon emissions. Most current practical transportation systems use liquid fuels, compressed gases, and/or stored electricity. While the use of pure electric vehicles has the potential to reduce or eliminate carbon emissions, on-board electric storage or generation technology has not yet advanced to the point where such vehicles have the range to be generally useful. Since liquid-fueled vehicles inherently emit carbon dioxide from their use, carbon emissions at best can be reduced, but not eliminated.

Thus there is a need in the art for a method and apparatus that uses liquid fuels having the capability of greatly reducing or eliminating carbon emissions.

### BRIEF SUMMARY

Certain embodiments are presented that include an energy system utilizing liquid fuels. The system may recycle some or all of the waste from the fuel. Thus, for example, the products of combustion are recycled into liquid fuels. In one embodiment, the recycling includes the use of solar energy so that the system is renewable, does not emit carbon dioxide, and results in a liquid fuel.

Certain other embodiments presented include an energy system utilizing a compound CₓH_{y}O_{z}, where x≧1, y≧4, and z≧0. The system includes a utilization unit to operate on the compound and an oxidizer, where the utilization unit produces a waste, and a fueling station, where at least a portion of the waste is recycled into the compound. The compound may be, for example and without limitation, dimethyl ether or methanol. The energy system may include storage for the compound and/or an oxidizer, and may include metering for the compound and/or waste.

Yet certain other embodiments presented include a fueling station to provide a compound CₓH_{y}O_{z}, where x≧1, y≧4, and z≧0, and where the fueling station accepts waste products from the use of the compound and an oxidizer. The fueling station includes a recycling unit to convert at least a portion of the waste products into the compound, such that the utilization of the compound generates waste products for recycling. The compound may be, for example and without limitation, dimethyl ether or methanol. The energy system may include storage for the compound and/or an oxidizer, and may include metering for the compound and/or waste.

Certain embodiments presented include a method for fueling a fuel utilization unit with a compound CₓH_{y}O_{z}, where x≧1, y≧4, and z≧0, where the method includes accepting waste products from the use of the compound, and converting at least a portion of the waste products into the compound.

These features together with the various ancillary provisions and features which will become apparent to those skilled in the art from the following detailed description, are attained by embodiments of the following energy systems and methods, preferred embodiments thereof being shown with reference to the accompanying drawings, by way of example only, wherein:

### BRIEF DESCRIPTION OF THE SEVERAL VIEWS OF THE DRAWING

FIG. 1 is a schematic diagram of a first embodiment of an energy system

FIG. 2 is a schematic diagram of a second embodiment of an energy system;

FIG. 3 is a schematic diagram of a third embodiment of an energy system;

FIG. 4 is a schematic diagram an alternative embodiments of an energy utilization component for an energy system; and

FIG. 5 is a schematic diagram of a fourth embodiment of an energy system.

Reference symbols are used in the Figures to indicate certain components, aspects or features shown therein, with reference symbols common to more than one Figure indicating like components, aspects or features shown therein.

### DETAILED DESCRIPTION

The following description includes several components of a closed or semi-closed energy system. In general, the system includes a power producing unit and a recycling unit. The recycling unit provides the power producing unit with fuel or fuel and oxidizer, and receives the products of power production and converts them back to fuel or fuel and oxidizer. Embodiments of the present invention include, in part, individual components, combinations of components, and methods of utilizing fuels in such a system.

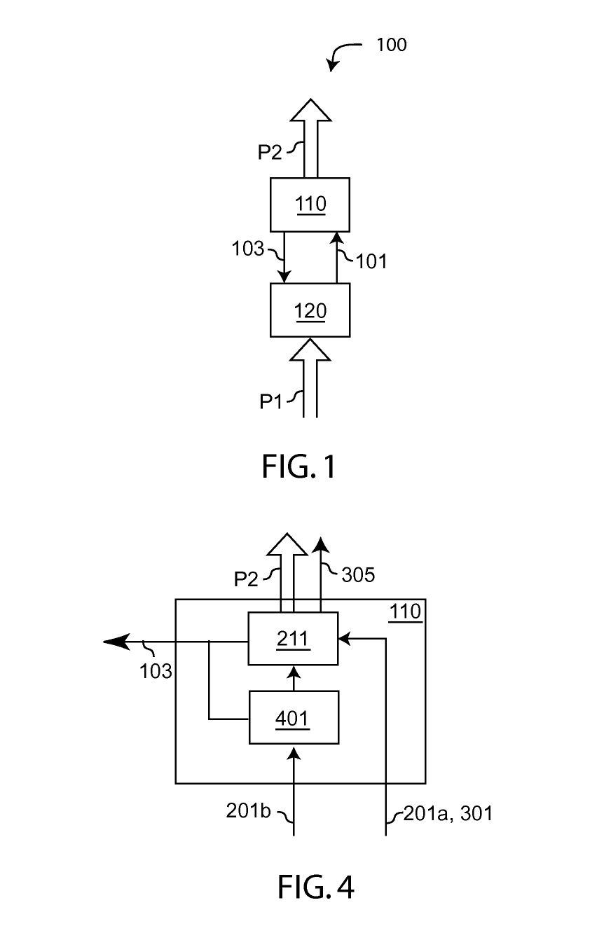

FIG. 1 is a schematic diagram of a first embodiment of an energy system 100. Generally, system 100 obtains power P1 and produces mechanical or electric power P2. Power P1 may be, for example and without limitation, obtained from thermal, solar, or mechanical sources. In one embodiment, power P1 is obtained from a renewable energy source, such as solar or wind energy. Power P2 may be, for example and without limitation, in the form of mechanical work or may be electric power.

System 100 includes a power-producing unit 110, which produces power P2, and a recycling unit 120, which accepts power P1. The overall energy and mass balance converts power P1 into power P2 by synthesizing a fuel (an “energy carrier”) that is usable as a transportation fuel. Also shown in FIG. 1 are lines which represent the flow of material (including gases and/or liquids) between units 110 and 120: a line 101 through which high energy content materials (including, but not limited to a fuel or a fuel and an oxidizer) flow from recycling unit 120 to power-producing unit 110, and a line 103 through which some or all of the products resulting from the use of the fuel are returned from the power-producing unit to the recycling unit. Lines 101 and 103, as well as any other lines described herein, may include tubes, pipes, valves, pumps, and storage containers, except as explicitly stated here. In addition to the material flow indicated in FIG. 1, there may be losses or addition of other materials and/or energy or power that are not shown in the figure.

In one embodiment, the material in line 101 includes a fuel, and line 103 includes products from the utilization of the fuel. The fuel may be any compound that may be combined with oxygen to release energy. It is preferred, though not necessary, that the fuel is a hydrogen-containing compound. In one embodiment, the fuel is a hydrocarbon. In another embodiment, the fuel is an organic molecule including carbon, oxygen and hydrogen. It is preferred, though not necessary, that the fuel is a liquid under standard conditions or that it can be easily stored as a fuel under conditions of modest pressure, such as propane. In another embodiment, the fuel is methane, which can be stored as compressed or liquefied natural gas.

Power-producing unit 110 may include, for example and without limitation, one or more of: an internal combustion engine (such as a diesel or Otto cycle engine), an external heat engine (such as a gas turbine engine), or an electrochemical device (such as a fuel cell). In addition, power-producing unit 110 may include energy or power storage devices such as batteries, holding tanks for fuel, or flywheels. In addition, for fuels stored under pressure, such as propane or compressed natural gas, power-producing unit 110 may include devices that can extract energy from expanding fluids, such as a turbine.

Recycling unit 120 includes processing equipment that converts waste products from power-producing unit 110 back into high-energy content material (such as a fuel or a fuel and oxidizer) for the power-producing unit. Examples of recycling unit 120 components include, but are not limited to, energy conversion units (for example, solar thermal, photovoltaic, or other devices to convert one form of energy into another), chemical or physical separation units to separate gases and/or liquids according to their composition, electrolyzes to increase the hydrogen content of feedstocks, and fuel synthesis units that can accept power P1 and convert the power-producing unit waste material into fuel. In one embodiment, power P1 is a solar flux, and recycling unit 120 includes a concentrator to produce thermal power or photovoltaic cells to produce electric power to drive the conversion.

In one embodiment, power-producing unit 110 and recycling unit 120 are be in the same general location, with a continuous conversion of power P1 into power P2. In an alternative embodiment, lines 101 and 103 can be disconnected from power-producing unit 110 and recycling unit 120, which can operate independently for period of time, either continuously or intermittently. Thus, for example and without limitation, recycling unit 120 can be stationary, and power-producing unit 110 can be mobile, and can be, for example and without limitation, the motor of a train or ship, and both the power-producing unit and recycling unit include material holding tanks. With power-producing unit 110 and recycling unit 120 are connected by lines 101 and 103, waste from the power-producing unit 110 is transferred to recycling unit 120 over line 103 and fuel or fuel and oxidizer are transferred from the recycling unit to the power-producing unit over line 101. The power-producing unit 110 and recycling unit 120 can then be separated: power-producing unit can generate power P2 from the materials stored from line 101 and waste materials can be stored for later discharging over line 103; and recycling unit 120 can accept power P1 and convert stored waste obtained over line 103 into fuel or fuel and oxidizer for later discharging over line 101. Recycling unit 120 thus operates as a fueling station.

In one embodiment, recycling unit 120 is grid-connected. In an alternative embodiment, the grid connection may include net metering of the amount of energy and/or materials. Thus, for example, recycling unit 120 may meter the amount of carbon-containing compounds provided to it and the amount of carbon-containing compounds provide by it, and thus calculate a net carbon production by power-producing unit 110.

In another embodiment, recycling unit 120 is stand-alone, and obtains all of its required energy from renewable energy sources, non-renewable energy sources, or some combination thereof.

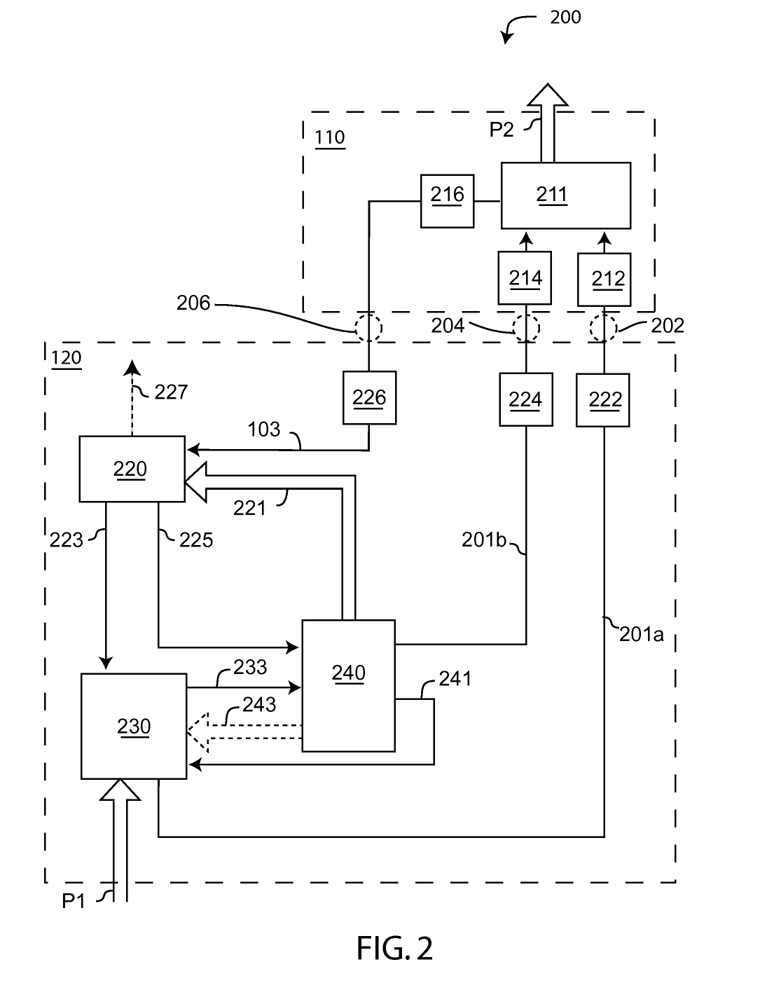

FIG. 2 is a schematic diagram of a second embodiment of an energy system 200 which may be similar to system 100, except as further detailed below.

Power-producing unit 110 is shown as including a conversion unit 211 and storage tanks 212, 214, and 216. Each of tanks 212, 214 and 216 may include a pressure vessel, compressors or expanders, and valves at an inlet and/or outlet to control the flow in and out of each tank.

Recycling unit 120 includes a separation unit 220, an electrolyzer unit 230, and a fuel synthesis unit 240, and storage tanks 222, 224, and 226. Each of tanks 222, 224 and 226 may include a pressure vessel and valves at an inlet and/or outlet to control the flow in and out of each tank. Circles 202, 204, and 206 indicate connectors that may be used to connect and disconnect oxidizer line 201a, fuel line 201b, and/or utilization waste line 103 between power-producing unit 110 and recycling unit 120. In an alternative embodiment, one or more of the connectors at circles 202, 204, or 206, or storage tanks 222, 224, or 226 may include flow meters to monitor the amount of materials transferred. This provides a way of charging for the amount of fuel and/or oxidizer provided, and/or the amount of waste product received. It also provides a way of tracking and/or charging for the net amount of carbon-based materials provided to power-producing unit 110

Also shown in FIG. 2 are lines indicating piping for transporting materials into, out of, or between units 210, 220, 230, and 240. Line 101 is shown as line 201a, for transporting oxidizer, and line 201b, for transporting fuel. Also shown is line 223, providing for material flow between separation unit 220 and electrolyzer unit 230, line 225, providing for material flow between the separation unit and the synthesis unit 240, line 233, providing for material flow between the electrolyzer unit and the synthesis unit, and line 241, providing for material flow between the synthesis unit and the electrolyzer unit. Also shown in FIG. 2 is arrow 221, which indicates the flow of power between synthesis unit 240 and separation unit 220, an optional arrow 243 indicating the flow of power between the synthesis unit and the electrolyzer unit, and an optional line 227 for discharging unrecyclable materials.

In one embodiment, fuel synthesis unit 240 is exothermic and is coupled to the endothermic separation unit 220 and, optionally or in addition, is coupled to electrolyzer unit 230 (as shown by the optional line 243, which indicates a flow of thermal, mechanical, or other forms of energy). It is thus preferred that units 220, 230, and 240, which form an energy carrier recycling system, are situated near one another, allowing for recycling of the fuel with little or no input of energy or other materials, other than that provided as power P1. Preferably, the waste heat of fuel synthesis unit 240 is sufficient to operate separation unit 220. For embodiments where units 220, 230, and 240 are in close proximity, excess energy may, in general, be shared between components to advantageously utilize energy within system 200. In addition, supplemental energy which may be, for example and without limitation, the sun, wind, hydroelectric, or other renewable energy source, or a fossil fuel or electricity, may also be provide to one or more of units 220, 230, and 240.

It is to be understood that each of the components indicated as conversion unit 211, separation unit 220, electrolyzer unit 230, and fuel synthesis unit 240 may be one or more physical components, or may be combined or part of other components. It is also to be understood that all lines, including but not limited to lines 103, 201a, 201b, 221, 223, 225, 233, 241, may be physical connections between, from or to units 211, 220, 230, and 240, that the lines may include valves or other devices, or may include storage devices that, for example, store chemical for later user by other components. The following discussion describes the operation of the interconnected units 211, 220, 230, and 240.

In one embodiment, prior to connecting power-producing unit 110 and recycling unit 120, the valves associated with tanks 212, 214, and 216 are in the proper open/closed configuration to permit conversion unit 211 to accept stored fuel and oxidizer in tanks 214 and 212, respectively, and provide waste for storage into tank 216. Further, the valves associated with tanks 222, 224 and 226 are in the proper open/closed configuration to permit separation unit 220 to accept waste stored in tank 226, for electrolyzer unit 230 to provide oxidizer to tank 222, and fuel synthesis unit to provide fuel to tank 224.

When power-producing unit 110 and recycling unit 120 are connected via connectors 214. The valves of tanks 212, 214, 216, 222, 224, and 226 are set in open/closed configuration to transfer fuel from tank 224 to tank 214, to transfer oxidizer from tank 222 to tank 212, and to transfer waste product from tank 216 to tank 226. With the materials thus transferred, the valves are closed between tanks 224 and 214, between tanks 222 and 212, and between tanks 216 and 226, and the power-producing unit 110 and recycling unit 120 can be disconnected.

While not meant to limit the scope of the present invention, energy system 200 will be described with respect to a system that utilizes a hydrogen-containing fuel in conversion unit 211.

Conversion unit 211 accepts fuel from tank 214 and oxidizer from tank 212. In various embodiments, conversion unit 211 is a combustion engine or a fuel cell that generates power P2 and exhaust products that are stored in tank 216.

Separation unit 220 accepts the stored waste product from tank 226 and separates part of the material for use in electrolyzer unit 230 and a portion in fuel synthesis unit 240. In one embodiment, the waste product is a combination of carbon dioxide and water, the separated portion in line 223 is water, and the separated portion in line 225 is a carbon-containing compound (such as a product of combustion). Separation unit 220 may accomplish phase separation, for example and without limitation, by physical means.

Electrolyzer unit 230 is an electric power or solar power device that accepts water from lines 223 and 241 and power P and optional energy 243 to produce oxygen, which is provided over line 201a to tank 220, and hydrogen, which is provided over line 233 to fuel synthesis unit 240. Electrolyzer unit 230 may be, for example and without limitation, an electrolyzer manufactured by Norsk Hydro ASA, of Oslo, Norway.

Fuel synthesis unit 240 accepts the carbon-containing compound from Separation unit 220 via line 225, hydrogen from electrolyzer unit 230 via line 233, and produces water via line 241 and fuel via line 201b. Some energy is provided as energy 221 to separation unit 220 and, optionally, as energy 243 to electrolyzer unit 230. Fuel synthesis unit 240 are may include, for example and without limitation, a Sabatier reactor, or a methanol synthesis unit as used for coal-to-liquid conversion.

In addition, to having a fuel in line 201b and an oxidizer in line 201a, non-reactive gases or liquids may present in either the fuel or oxidizer as diluents. Thus, for example, the oxidizer or fuel may contain a species that does not appreciably react with the fuel and oxidizer, such as nitrogen, carbon dioxide, water, or argon. One alternative embodiment provides for some of a diluent from line 225 for combining with the oxidizer of line 201a.

For illustrative purposes which are not meant to limit the scope of the invention, a specific fuel, dimethyl ether (CH₃OCH₃), will be described as part of energy system 100. Dimethyl ether which is also known as methoxymethane, and which is referred to herein as “DME.” DME is converted in conversion unit 211 by reaction with oxygen (O₂) according to:

CH₃OCH₃+3 O₂→2 CO₂+3 H₂O,

where DME is provided by line 201b, O₂ is provided by line 201a, and the products (CO₂ and H₂O) flow through line 103. In one alternative embodiment, some of the products from line 103 are provided back to conversion unit 211 to dilute reactions within the conversion unit. In one embodiment, dilution occurs by combining the gases with one or more of the gas in line 201a and/or 201b. Alternatively dilution may take place within a mixed fuel and oxidizer mixture within conversion unit 211. Examples of conversion unit 211 include, but are not limited to an internal combustion engine, a turbine engine, or a fuel cell.

Products from conversion unit 211 are provided through line 103 to separation unit 220. The products generally include two or more chemical species. Separation unit 220 separates the products in line 103 by chemical, physical, thermal, or any other technique. Separation requires an input of energy or work as indicated by line 221. The materials leaving separation unit 220 include a hydrogen-containing unit, such as water, which flows through line 223 and a carbon-containing compound, such as carbon dioxide, which flows through line 225. In an alternative embodiment, line 227 provides for the emission of unseparable materials. As a specific example of a DME fuel, line 223 contains water and line 225 contains carbon dioxide.

Alternatively, a portion of power P2, fuel from line 201b, and/or oxidizer from line 201a may be diverted to augment or replace energy 221 or 243. Thus, for example, additional fuel may be provided to conversion unit 211 to produce additional power, or conversion unit 211 may include a turbine, and separation unit 220 may include a compressor mechanically coupled to the turbine. In another embodiment, a portion of power P1 is provided to unit 230.

The hydrogen-containing compound (from lines 223 and 241) enters electrolyzer unit 230, which also accepts energy 243, and produces hydrogen, through line 233, and an oxidizer through line 201a. Examples of electrolyzer unit 230 include, but are not limited to water electrolyzers. In certain embodiments, electrolyzer unit 230 is solar-powered.

For the specific example of a DME fuel, line 223 contains water, line 233 contains hydrogen and line 235 contains oxygen.

The carbon-containing compound in line 225 and the hydrogen-containing compound in line 233 enters fuel synthesis unit 240, and produces a fuel in line 201b and a hydrogen-containing compound in line 241, which is provided to electrolyzer unit 230.

For the specific example of a DME fuel, line 225 contains carbon dioxide, line 233 contains hydrogen, and the reaction that takes place in fuel synthesis unit 240 is:

2 CO₂+6 H₂→CH₃OCH₃+3 H₂O.

The energy system thus described can be generalized for other fuels or energy carriers. Representing the fuel in line 201b as CₓH_{y}O_{z} and the oxidizer in line 201a as O₂, conversion unit 211 produces products in line 103 according to:

CₓH_{y}O_{z}+(x+y/4−z/2)O₂=x CO₂+y/2 H₂O, Eq (1)

which are separated into their component parts (CO₂ and H₂O) in separation unit 220. Fuel synthesis unit 240 operates according to the overall reaction:

x CO₂+(y/2+2x−z)H₂=CₓH_{y}O_{z}+(2x−z)H₂O, and

electrolyzer unit 230 operates according to:

y/2 H₂O (from line 223)+(2x−z)H₂O (from line 241)=(y/2+2x−z)H₂+(y/4+x−z/2)O₂.

As explicit examples, which are not meant to limit the scope of the present invention, the indices (x,y,z) in Eq (1) may be (2, 6, 1), for DME or for ethanol, (1, 4, 0) for methanol.

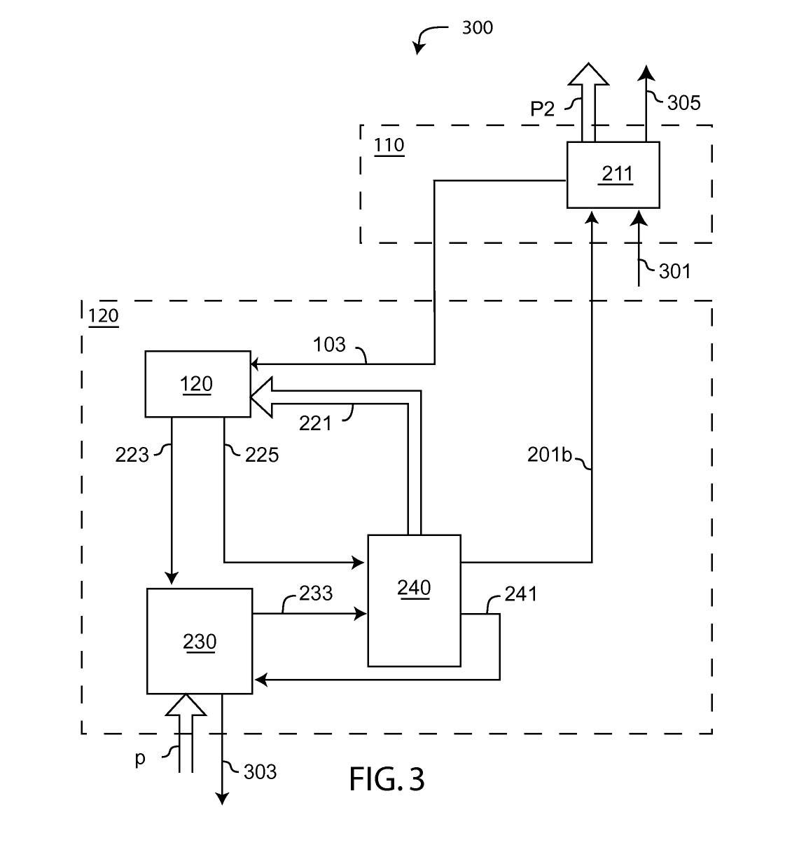

In an alternative embodiment, power-producing unit 110 accepts fuel and/or oxidizer from other sources. FIG. 3 is a schematic diagram of a third embodiment of an energy system 300 which may be similar to systems 100 or 200 except as further detailed below. Where possible, similar elements are identified with identical reference numerals in the depiction of the embodiments of FIGS. 1, 2, and 3.

As shown in FIG. 3, line 201a of FIG. 2 has been replaced with a line 301 leading into conversion unit 211 and a line 303 leading from electrolyzer unit 230, and no oxidizer is transferred from power-producing unit 110 to recycling unit 120. Line 301 draws in air (which may be compressed) from the atmosphere and line 303 rejects oxidizer from the electrolyzer unit 230, which may be stored or used elsewhere, or may be rejected to the atmosphere. An alternative line 305 is shown leading away from conversion unit 211. Line 305 may, for example, reject nitrogen and/or water vapor into the atmosphere.

Energy system 300 may also include tanks, similar to storage tanks 212, 214, 216, 222, 224, or 226, and associated valve, and connectors between the tanks.

FIG. 4 is a schematic diagram an alternative embodiment of a power-producing unit 410 which may be similar to conversion units 110, 210, or 310, except as further detailed below. Where possible, similar elements are identified with identical reference numerals in the depiction of the embodiments of FIGS. 1, 2, 3, and 4.

Power-producing unit 410 includes a reformer 401. Reformer 401 is a chemical processing unit that produces hydrogen from a hydrogen-containing fuel. Thus, for example, a hydrocarbon or alcohol or ether in line 201b is converted into hydrogen, which is supplied to conversion unit 211 and carbon dioxide, which is feed into line 103. The hydrogen and oxidizer from line 201a or 301 are combined in conversion unit 211 to produce power P2 and water, which is fed into line 103. Alternatively, the waste from conversion unit 211 and reformer 401 may be provided into separate lines, which may be stored separately and which may reduce the burden of separation unit 220 to separate the waste streams.

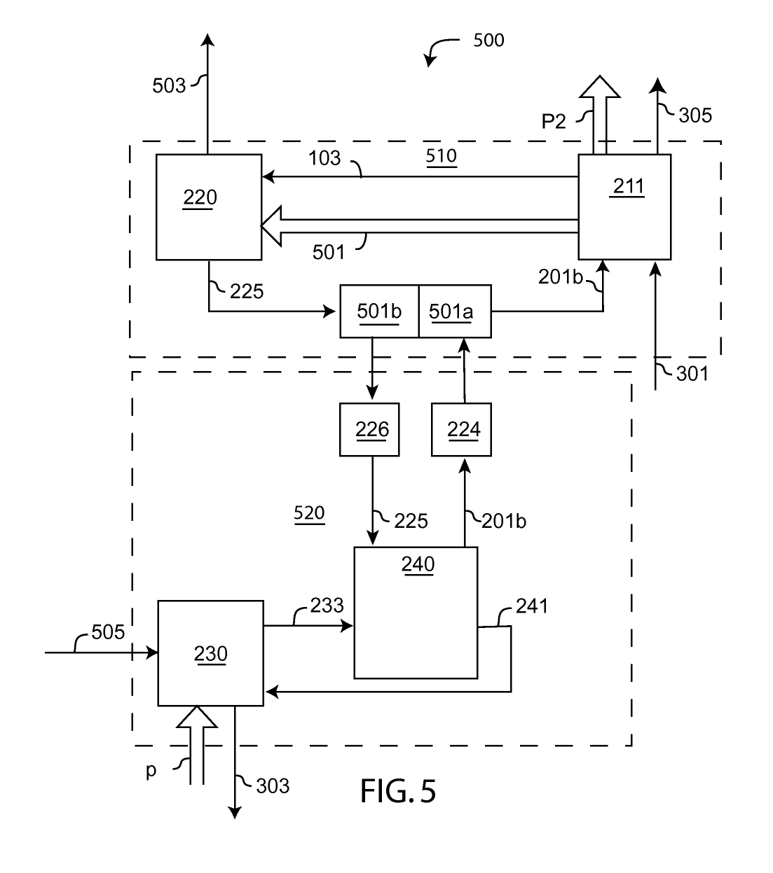

FIG. 5 is a schematic diagram of a fourth embodiment of an energy system 500, which may be similar to systems 100, 200, or 300 except as further detailed below. Energy system 500 includes a power-producing unit 510, which is generally similar to power-producing unit 110, and a recycling unit 520, which is generally similar to recycling unit 120, except as further detailed below. Where possible, similar elements are identified with identical reference numerals in the depiction of the embodiments of FIGS. 1, 2, 3, 4 and 5.

In energy system 500, separation occurs in power-producing unit 510, and water is not recycled through the system. Thus, for example, power-producing unit 510 includes separation unit 220 which alternatively receives power 501 (either mechanical or electrical) from conversion unit 211. Water from separation unit 220 (which in energy system 200 is transferred over line 233), is transferred through line 503 and is used or disposed of outside of energy system 500. The carbon-containing compound in line 225 is returned to recycling unit 520. Recycling unit 520 receives water from an outside source via a line 505.

In one embodiment, power-producing unit 510 includes a tank having two portions—tank portion 501a and 501b and recycling unit 520 includes tank 224 and 226. Tank 501a dispenses fuel to conversion unit 210 and tank 501b receives carbon-containing compound from separation unit 220. The total volume of material within tanks 501a and 501b at any time is approximately constant, and a single pressure vessel may be used with a bladder separating the tanks.

Tanks 224 and 226 may be fitted with meters to permit the metering of carbon-containing compounds into and out of recycling unit 520. Such metering may be useful for implementing carbon reduction or trading schemes.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention.

We claim:

1. An energy system utilizing a compound CₓH_{y}O_{z}, where x≧1, y≧4, and z≧0, said system comprising:
a utilization unit to operate on the compound and an oxidizer, where said utilization unit produces a waste; and
a fueling station, where at least a portion of the waste is recycled into the compound.

2. The energy system of claim 1, where said compound is dimethyl ether.

3. The energy system of claim 1, where said compound is methanol.

4. The energy system of claim 1, where said utilization unit includes storage for the compound and at least a portion of the waste.

5. The energy system of claim 4, where said utilization unit includes storage for an oxidizer.

6. The energy system of claim 4, where said utilization unit obtains an oxidizer from the atmosphere.

7. The energy system of claim 1, where, in said utilization unit, the compound is reformed at least partially into hydrogen.

8. The energy system of claim 1, where said fueling station includes a separation unit, an electrolyzer unit, and a fuel synthesis unit.

9. The energy system of claim 1, where said fueling station includes an electrolyzer unit, and a fuel synthesis unit, and where said utilization unit includes a separation unit.

10. The energy system of claim 1, where said fueling station include storage for the compound.

11. The energy system of claim 10, where said fueling station includes storage for an oxidizer.

12. The energy system of claim 1, where said fueling station is at least partially powered by renewable energy.

13. The energy system of claim 1, further including a meter for said waste and said compound.

14. A fueling station to provide a compound CₓH_{y}O_{z}, where x≧1, y≧4, and z≧0, and where said fueling station accepts waste products from the use of the compound and an oxidizer, said fueling station comprising:
a recycling unit to convert at least a portion of the waste products into the compound,
such that the utilization of the compound generates waste products for recycling.

15. The fueling station of claim 14, where said compound is dimethyl ether.

16. The fueling station of claim 14, where said compound is methanol.

17. The fueling station of claim 14, where said fueling station includes an electrolyzer unit, and a fuel synthesis unit.

18. The fueling station of claim 14, where said fueling station further includes a separation unit.

19. The fueling station of claim 14, where said fueling station includes storage for the compound.

20. The fueling station of claim 14, where said fueling station includes storage for an oxidizer.

21. The fueling station of claim 14, where said fueling station is at least partially powered by renewable energy.

22. The fueling station of claim 14, further including a meter for said waste and said compound.

23. A method for fueling a fuel utilization unit with a compound CₓH_{y}O_{z}, where x≧1, y≧4, and z≧0, where said method includes:
accepting waste products from the use of the compound; and
converting at least a portion of the waste products into the compound.

24. The method of claim 23, where said compound is dimethyl ether.

25. The method of claim 23, where said compound is methanol.

26. The method of claim 23, where said converting includes:
separating a portion of the waste products into a first stream and a second stream;
electrolyzing a portion of said first stream into hydrogen and an oxidizer; and
forming the compound from the second stream and said hydrogen.

27. The method of claim 23, further comprising storing the compound.

28. The method of claim 23, further comprising storing an oxidizer.

29. The method of claim 23, where said converting includes using a renewable energy source.

30. The method of claim 29, where said renewable energy source includes solar energy.

31. The method of claim 29, further including metering said waste and said compound.
